(19) United States
(12) Patent Application Publication
(10) Pub. No.: US 2008/0139277 A1
(43) Pub. Date: Jun. 12, 2008

(54) Gaming apparatus and control method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/902,699

(22) Filed: Sep. 25, 2007

Related U.S. Application Data
(60) Provisional application No. 60/873,576, filed on Dec. 8, 2006.

(51) Int. Cl. G06F 17/00

(52) U.S. Cl. 463/17; 463/43

(57) ABSTRACT

A gaming apparatus comprises a roulette wheel having a plurality of number pockets. The roulette wheel includes a plurality of pocket groups, each of which being composed of a plurality of number pockets. In addition, the roulette wheel has a plurality of areas provided therein and each of the pocket groups belongs to the areas respectively. One control data is used for rotation of the roulette wheel and throw-in of a ball. Each of the control data raises the probability of receiving the ball into a number pocket within a specific area among the plurality of areas higher than that in other areas. In each game, when the number of bets on the specific number pocket (the specific pocket is included within the specific area with the higher probability of receiving the ball based on the current control data) reaches a predetermined threshold value, the next control data is changed.

### CROSS-REFERENCE TO RELATED APPLICATION

This application is based upon and claims the benefit of U.S. Provisional Patent Application Ser. No. 60/873,576, filed on Dec. 8, 2006; the entire contents of which are incorporated herein by reference for all purposes.

### BACKGROUND OF THE INVENTION

1. Field of the Invention

The present invention relates to a gaming apparatus such as a roulette gaming machine and a bingo gaming machine and to a control method thereof.

2. Description of Related Art

With conventional roulette games, the game has been usually played by the dealer's throw-in of a ball onto a roulette wheel. In recent years, progress of automation has raised proposals of gaming apparatuses which advance the roulette game in a fully-automatic manner without requiring the dealer to throw in the ball.

Such gaming apparatuses include one that launches the ball using air, as disclosed in International Patent Publication WO2004/094013. With gaming devices that advance the roulette game in a fully-automatic manner, it is preferred that the balls fall on to be received into respective pockets with a uniform probability. To this end, there are some gaming apparatuses designed to disturb the behavior of the ball by providing irregularities on the surface of the ball track so that the ball falls into respective pockets at a uniform probability.

It is an object of the present invention to provide a new entertainment characteristic by suitably varying the probability that the ball is received into each pocket.

### SUMMARY OF THE INVENTION

A gaming apparatus according to a first aspect of the present invention comprises a roulette wheel which rotates around its center axis; a plurality of pockets sequentially arranged on the roulette wheel for receiving a ball; a memory for storing a plurality of control data used for controlling the pocket which receives the ball launched onto the periphery of the roulette wheel in each game; and a controller operable to control, in each game, the pocket which receives the launched ball using one of the plurality of control data stored in the memory. The control data raises the probability of receiving the ball in a specific pocket among the plurality of pockets, relatively higher than the probability of receiving the ball in the pockets other than the specific pocket. The specific pocket with the higher probability of receiving the ball is different for each of the control data. The controller is operable to (a) accumulate the number of the game media bet on the specific pocket with the higher probability of receiving the ball for each game when the pocket having game media bet thereon is the specific pocket, and (b) switch the control data when the accumulated number of the game media reaches a predetermined value.

A gaming apparatus according to a second aspect of the present invention comprises a roulette wheel which rotates around its center axis; a plurality of areas provided on the roulette wheel; a plurality of pockets sequentially arranged on the roulette wheel for receiving a ball; a memory for storing a plurality of control data used for controlling the pocket which receives the ball launched onto the periphery of the roulette wheel in each game; and a controller operable to control, in each game, the pocket which receives the ball using one of the plurality of control data stored in the memory. Each of the areas has a pocket group, respectively. Each of the pocket groups is composed of the successive pockets which belong to the same area respectively. The control data raises the probability of receiving the ball in the pocket group included a specific area among the plurality of areas, relatively higher than the probability of receiving the ball in the pocket groups included the areas other than the specific area. The specific area including the pocket group with the higher probability of receiving the ball is different for each of the control data. The controller is operable to (a) accumulate the number of the game media bet on the pocket with the higher probability of receiving the ball included the specific area for each game when the area including the pocket having the game media bet thereon is the specific area, and (b) switch the control data when the accumulated number of the game media reaches a predetermined value.

A method of controlling a gaming apparatus according to a third aspect of the present invention comprises the following configuration. The gaming apparatus comprising a roulette wheel which rotates around its center axis; a plurality of pockets sequentially arranged on the roulette wheel for receiving a ball; a ball launched onto the peripheral of the roulette wheel in each game; and a plurality of control data used for controlling the pocket which receives the ball. The control data raises the probability of receiving the ball in a specific pocket among the plurality of pockets, relatively higher than the probability of receiving the ball in the pockets other than the specific pocket. The specific pocket with the higher probability of receiving the ball is different for each of the control data. The method comprising: (a) accumulating the number of the game media bet on the specific pocket with the higher probability of receiving the ball for each game when the pocket having game media bet thereon is the specific pocket, and (b) switching the control data when the accumulated number of the game media reaches a predetermined value.

A method of controlling a gaming apparatus according to a fourth aspect of the present invention comprises the following configuration. The gaming apparatus comprising a roulette wheel which rotates around its center axis; a plurality of areas provided on the roulette wheel; a plurality of pockets sequentially arranged on the roulette wheel for receiving a ball; a ball launched onto the peripheral of the roulette wheel for each game; and a plurality of control data used for controlling the pocket which receives the ball. Each of the areas has a pocket group, respectively. Each of the pocket groups is composed of the successive pockets which belong to the same area respectively. The control data raises the probability of receiving the ball in the pocket group included a specific area among the plurality of areas, relatively higher than the probability of receiving the ball in the pocket groups included the areas other than the specific area. The specific area including the pocked group with the higher probability of receiving the ball is different for each of the control data. The method comprising: (a) accumulating the number of game media bet on the pocket with the higher probability of receiving the ball included the specific area for each game when the area including the pocket having the game media bet thereon is the specific area, and (b) switching the control data when the accumulated number of the game media reaches a predetermined value.

### BRIEF DESCRIPTION OF THE DRAWINGS

FIG. 1 is a plan view of a roulette apparatus according to an embodiment of the present invention.

FIG. 2 is a diagram illustrating exemplary control data.

FIG. 3 is an exterior perspective view illustrating the general structure of the roulette gaming machine according to the embodiment of the present invention.

FIG. 4 is a diagram illustrating an exemplary image displayed by a display panel.

FIG. 5 is a block diagram illustrating an internal configuration of the roulette gaming machine according to the embodiment of the present invention.

FIG. 6 is a schematic view illustrating a storage area of a ROM of the roulette gaming machine according to the embodiment of the present invention.

FIG. 7 is a schematic view illustrating a storage area of a RAM of the roulette gaming machine according to the embodiment of the present invention.

FIG. 8 is a block diagram illustrating an internal configuration of the roulette apparatus according to the embodiment of the present invention.

FIG. 9 is a schematic view illustrating a storage area of a ROM of the roulette apparatus according to the embodiment of the present invention.

FIG. 10 is a block diagram illustrating an internal configuration of a station according to the embodiment of the present invention.

FIG. 11 is a flow chart illustrating a game processing of the roulette gaming machine according to a first embodiment of the present invention.

FIG. 12 is a flow chart illustrating the game processing of the roulette gaming machine according to the first embodiment of the present invention.

FIG. 13 is a flow chart illustrating the game processing of the roulette gaming machine according to the first embodiment of the present invention.

FIG. 14 is a flow chart illustrating a game processing of a roulette gaming machine according to a second embodiment of the present invention.

FIG. 15 is a flow chart illustrating a game processing of the roulette gaming machine according to the second embodiment of the present invention.

FIG. 16 is a flow chart illustrating a game processing of the roulette gaming machine according to the second embodiment of the present invention.

### DETAILED DESCRIPTION OF THE EMBODIMENT

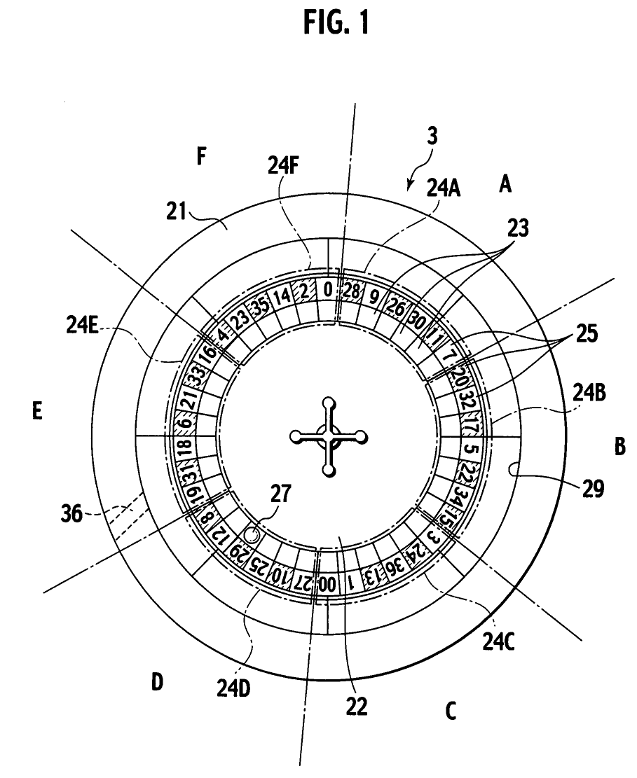

A roulette gaming machine according to a first embodiment of the present invention will be described in the following with reference made to FIGS. 1 to 13.

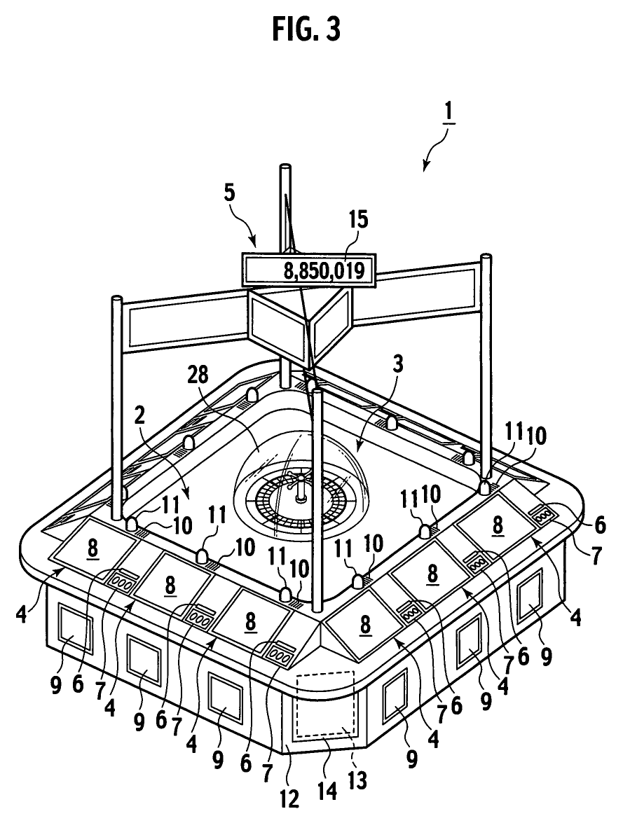

FIG. 1 is a plan view of a roulette apparatus provided in the roulette gaming machine according to the first embodiment of the present invention. FIG. 3 is an exterior perspective view illustrating the general structure of the roulette gaming machine according to the first embodiment of the present invention having the roulette apparatus of FIG. 1. Here, a roulette gaming machine 1 is a stand-alone type gaming apparatus which is not connected to a network. However, the present invention can be applied to a gaming apparatus connected to the network.

As shown in FIG. 1, a roulette apparatus 3 provided in the roulette gaming machine 1 (the roulette gaming machine 1 corresponds to the gaming apparatus of the present invention) includes a frame 21 which is fixed to a housing 2 (see FIG. 3) and a roulette wheel 22 which is rotatably accommodated and supported inside the frame 21. On the top surface of the roulette wheel 22, multiple (a total of 38 pockets in the present embodiment) number pockets 23 are formed (the number pockets 23 corresponds to the pockets in the claims). Furthermore, number plates 25 displaying respective numbers “0”, “00”, “1” to “36” which correspond to respective number pockets 23 are provided on the upper surface of the roulette wheel 22 along the outer peripheral of the number pockets 23.

The roulette wheel 22 is divided into six areas, A to F. To each of the areas A to F belongs each of pocket groups 24A to 24F, respectively. Each of the pocket groups 24A to 24F (areas A to F) is composed of six or seven number pockets 23.

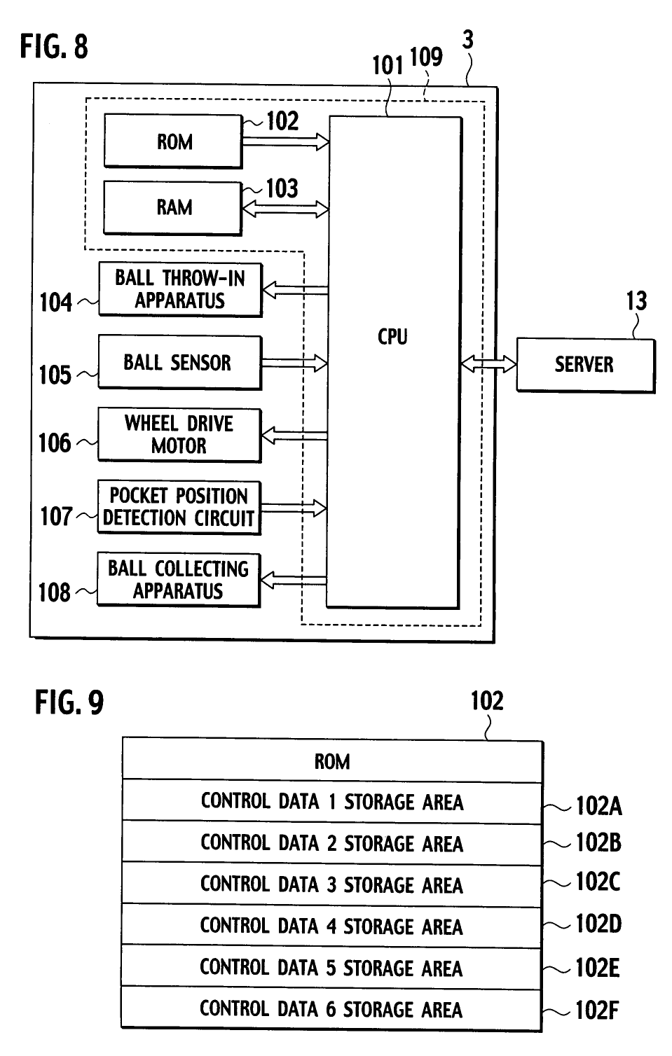

A ball throw-in opening 36 is formed inside the frame 21. A ball throw-in apparatus 104 (see FIG. 8) is coupled to the ball throw-in opening 36. A ball 27 is thrown onto the roulette wheel 22 from the ball throw-in opening 36 as the ball throw-in apparatus 104 is driven. In addition, the upside of the entire roulette apparatus 3 is covered by a hemispheric cover member 28 (see FIG. 3) made of transparent acryl.

A wheel drive motor 106 is provided below the roulette wheel 22 has (see FIG. 8). The roulette wheel 22 rotates as the wheel drive motor 106 is driven. In addition, metal plates (not shown) are attached on to the back surface of the roulette wheel 22 at predetermined intervals. The position of the number pocket 23 is identified by detecting the metal plate with a proximity sensor of a pocket position detecting circuit 107 (see FIG. 8).

The frame 21 is gradually tilted inward and has a guide wall 29 formed in the intermediary part thereof. The thrown-in ball 27 is guided and rotates along the guide wall 29 by its centrifugal force. As the ball 27 reduces its rotation speed and loses its centrifugal force, it rolls down the slope of frame 21 inward and reaches the rotating roulette wheel 22. Then, the ball 27 which reached the roulette wheel 22 passes over the number plates 25 on the outer periphery of the rotating roulette wheel 22 and is received into any of the number pockets 23. As a result, the number displayed on the number plate 25 corresponding to the receiving number pocket 23 is determined by a ball sensor 105 (see FIG. 8). This number is a winning number.

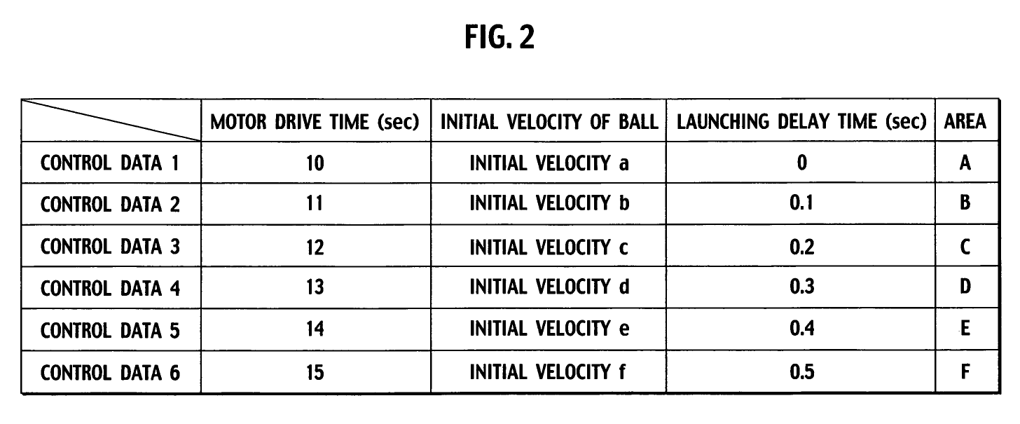

Rotation of the roulette wheel 22 and launch of the ball 27 are controlled based on control data. FIG. 2 shows an exemplary table of control data.

As shown in FIG. 2, six control data 1 to 6 are provided in the present embodiment. Each control data control data 1 to 6 includes motor drive time, initial velocity of the ball, and launching delay time. The motor drive time is a time for driving the wheel drive motor 106 (see FIG. 8). The roulette wheel 22 is rotated by the wheel drive motor 106 at a predetermined rotation speed for the motor drive time. After the drive by the wheel drive motor 106 is ended, the roulette wheel 22 gradually reduces its rotation speed and eventually comes to a stop. The initial velocity of the ball is the initial velocity when the ball 27 is thrown in from the ball throw-in apparatus 104. The launching delay time is the time from when a predetermined number pocket 23 passes by a predetermined position until the ball is launched during the rotation of the roulette wheel 22.

The purpose that each control data control data 1 to 6 includes the above parameters (the above-mentioned motor drive time, initial velocity of the ball, and launching delay time) is to make the ball-receiving area to be concentrated on a specific area among the areas A to F. Therefore, by setting the parameter appropriately, rotation of the roulette wheel 22 and launch of the ball 27 are controlled based on each control data 1 to 6 so that the ball 27 is received into number pockets 23 which belong to the specific area A to F with a high probability.

With the present embodiment, the motor drive time, the initial velocity of the ball, and the launching delay time of the control data 1 to 6 are different from one another. Accordingly, the area having a higher probability of receiving the ball 27 among areas A to F differs for each control data 1 to 6, as shown in FIG. 2. For example, controlling the rotation of the roulette wheel 22 and launch of the ball 27 based on the control data 1 of “motor drive time: 10 sec, initial velocity of the ball: a, and launching delay time: zero”, will provide a higher probability of receiving the ball 27 in the area A (pocket group 24A). Therefore, each control data 1 to 6 also includes the areas A to F that may have a higher probability of receiving the ball 27.

Here, respective parameters (the motor drive time, the initial velocity of the ball, and the launching delay time) of the control data 1 to 6 can be commonly applied to all of the roulette gaming machines 1. However, respective parameters (the motor drive time, the initial velocity of the ball, and the launching delay time) of the control data 1 to 6 may be separately set for each of the roulette gaming machines 1, if the ball-receiving probability of a specific area A to F varies due to individual difference in the structure of the roulette apparatus 3.

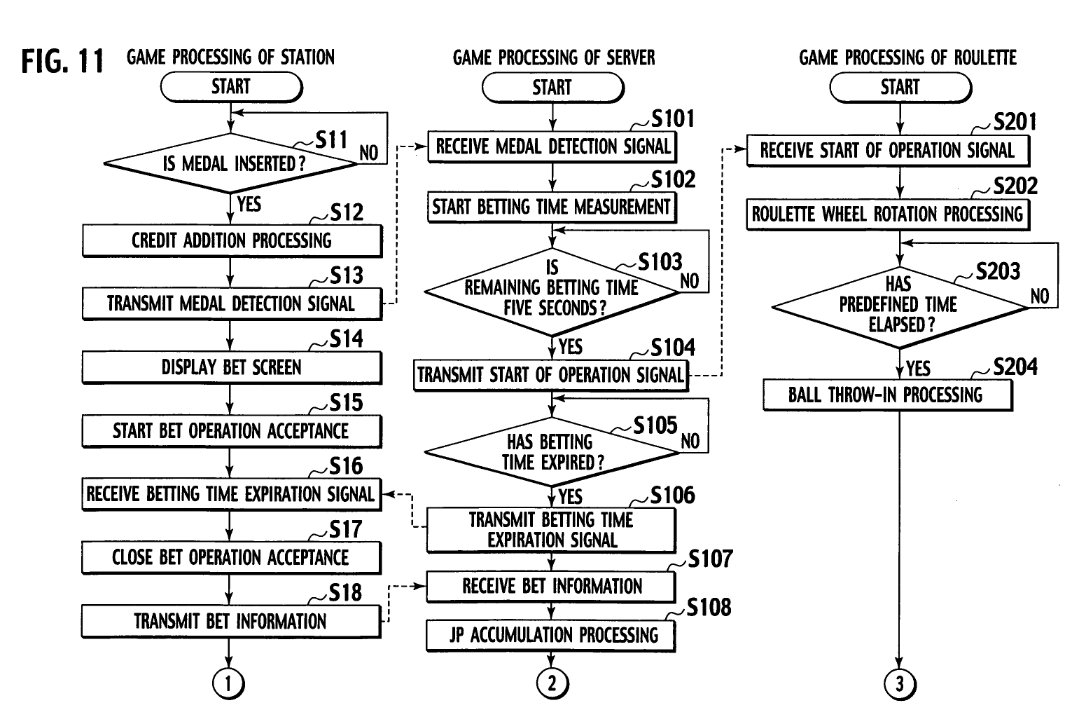

The control data 1 to 6 (referred to when controlling the rotation of the roulette wheel 22 and launch of the ball 27 for each game) are switched when a predetermined condition is met. In the present embodiment, whether or not the predetermined condition is met will be determined in association with the number of bets by the player at each station 4. Specifically, whether or not the predetermined condition is met will be determined in association with the number of bets on the specific area among A to F. The specific area (six or seven number pockets 23) has a higher probability of receiving the ball according to the current control data 1 to 6. The predetermined condition will be discussed in detail when describing the game processing of the server based on the flow charts of FIGS. 11 to 13.

In the above-mentioned example, a case has been described in which each of the pocket groups 24A to 24F is composed of six or seven number pockets 23. In the present invention, however, the numbers of number pockets 23 composing each of the pocket groups 24A to 24F are not particularly limited. In addition, the numbers of number pockets 23 composing each of the pocket groups 24A to 24F may be identical to or different from one another.

Additionally, in the above-mentioned example, a case has been described in which the roulette wheel 22 is divided into six areas A to F. In the present invention, however, the number of areas dividing the roulette wheel 22 is not limited to six.

Furthermore, in the above-mentioned example, a case has been described in which the areas A to F are not overlapping with one another. In other words, a case has been described in which a number pocket 23 belonging to one of the areas A to F does not belong to any of the other areas. In the present invention which is by no means limited by the above, however, a part of two or more areas of A to F may be overlapped with one another and a number pocket 23 may belong to two or more of areas A to F.

Additionally, in the above-mentioned example, six control data 1 to 6 corresponding to respective areas A to F are provided for selecting from among areas A to F to which the number pockets 23 having a higher probability of receiving the ball 27 belong. However, the number of the control data in the present invention need not be equal to the number of corresponding areas A to F, provided that there are more than one of data sets.

Furthermore, in the above-mentioned example, a case has been described in which the control data 1 to 6 are composed of motor drive time, initial velocity of the ball, and launching delay time. In the present invention which is by no means limited to the above, however, the control data 1 to 6 may include any one or a combination of data relating to rotation control of the roulette wheel 22 (motor drive time), data relating to launch timing of the ball 27 (the launching delay time), or data relating to initial velocity of the ball 27 (initial velocity of the ball). Rotation speed of the roulette wheel 22, for example, may be used as the data relating to rotation control of the roulette wheel 22, besides the motor drive time.

Next, the structure of the roulette gaming machine 1 will be described.

As shown in FIG. 3, the roulette gaming machine 1 includes a housing 2 which is the main body, a roulette apparatus 3 provided almost in the central part of the top surface of the housing 2, a plurality (twelve in the present embodiment) of stations 4 provided so as to surround the roulette apparatus 3, and an electric light display 5 provided above the housing 2.

The station 4 includes, at least, a medal insertion slot 6 for inserting game media (currency value: such as coins, chips, medals or the like), a console 7 composed of a plurality of control buttons with which the player inputs predetermined directions, and a display panel 8 for displaying game-related images. The station 4 uses the medal insertion slot 6, the console 7, and the display panel 8 to accept the player's betting operation. The player can advance the game by operating the touch screen or the console 7 while watching the images displayed on the display panel 8. Here, game media may be collectively referred to as “medal” in the following description.

In addition, medal payout opening 9 is provided, respectively, on the side of the stations 4. Furthermore, a speaker 10 for playing music or effect sound is mounted on the upper right side of the display panel 8 of each station 4.

On the top of the display panel 8 of each station 4, WIN lamps 11 are provided, respectively. When a number bet at the station 4 in a game (“0”, “00”, “1” to “36” in the present embodiment) is won, the WIN lamp 11 at the winning station 4 lights up. Similarly, the WIN lamp 11 also lights up at the station 4 that has won the jackpot (hereinafter, referred also to JP) in a JP bonus game. The WIN lamps 11 are provided at positions that can be recognized visually from all of the stations 4 (12 units in the present embodiment). It is possible for other players playing with the same roulette gaming machine 1 to check the lighting of the WIN lamp 11 at all times.

Within the medal insertion slot 6, a medal sensor 97 (not shown) is provided. The medal sensor 97 identifies the currency value of the medal inserted through the medal insertion slot 6 as well as counting the inserted medals. In addition, a hopper 94 (not shown) is provided within the medal payout opening 9. The hopper 94 pays out a predetermined number of medals from the medal payout opening 9.

Within a corner 12 of the cabinet 2, a server 13 is installed. The server 13 is accommodated within the corner 12 so as to prevent operations by a player. It is possible for an administrator of the roulette gaming machine 1 to operate the server 13 by opening a door 14 on the corner 12 using a key switch. Then, by operating the server 13, it is possible to set various settings of the roulette gaming machine 1.

On the electric light display 5, a JP amount display 15 for displaying the amount of JP is provided. In the roulette gaming machine 1 according to the present embodiment, three kinds of JP, that is, “MEGA”, “MAJOR”, and “MINI” are provided, as will be described later. The “MEGA” JP accumulates and stores 0.15% of credits bet at all of the 12 stations 4. The “MAJOR” JP accumulates and stores 0.20% of bet credits. The “MINI” JP accumulates and stores 0.30% of bet credits. Then, one of JPs is won in a JP bonus game, which will be described later, the credits corresponding to the accumulated amount of the relevant JP are paid out for the predetermined station 4. On the JP amount display 15, the accumulated amount of the “MEGA” JP is displayed among the three kinds of JP. The JP amount display 15 is provided on the top part of the bet 5 and the display contents can be visually recognized by all of the players who play at the stations 4.

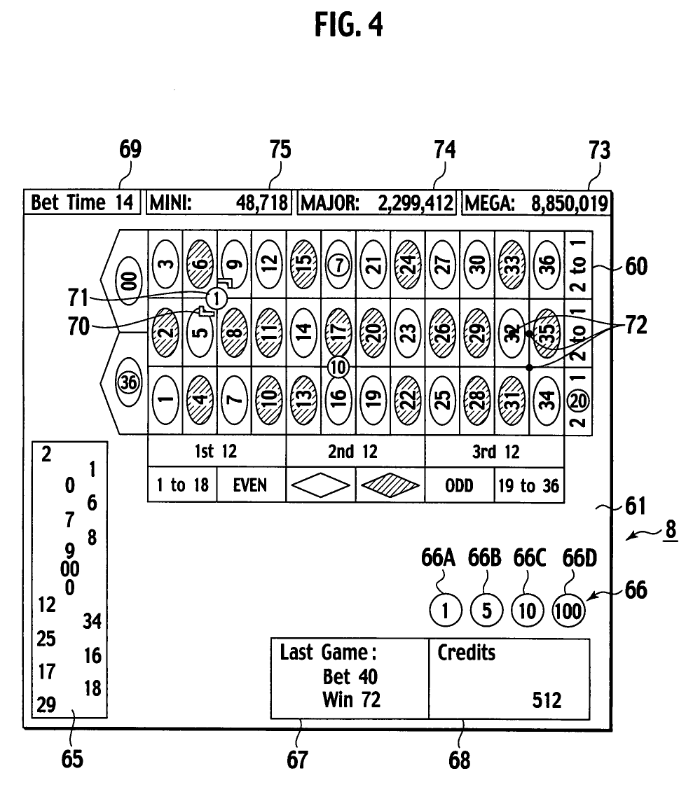

FIG. 4 is a diagram showing an example of an image displayed on the display panel.

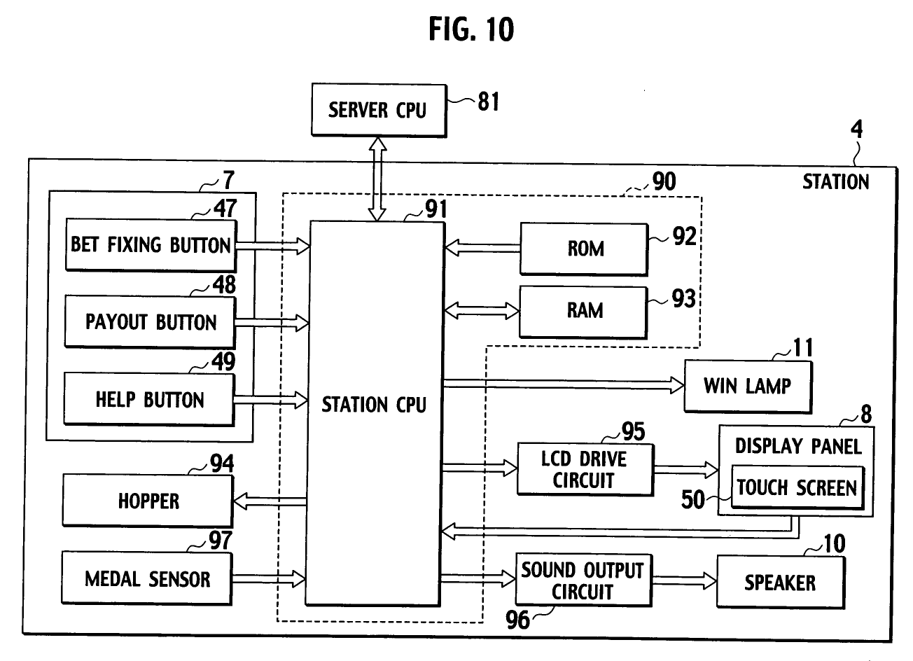

As shown in FIG. 4, during a game, a bet screen 61 having a betting board 60 is displayed on the display panel 8. The player can bet a chip using the own credits with the touch screen 50 (refer to FIG. 10) provided on the front of the display panel 8.

First, based on FIG. 4, the bet screen 61 during a game will be described. On the betting board 60 displayed on the bet screen 61, 38 kinds of numbers, that is, “0”, “00”, “1” to “36”, are arranged and displayed in a matrix. In addition, specific bet areas are also arranged in a matrix for betting a chip by specifying “odd numbers”, “even numbers”, “the kind of color (red or black) of the number plate”, and “a certain range of numbers (for example, “1” to “12”, etc.”).

Below the betting board 60, a result history display 65, a denomination bet button 66, a payout result display 67, and a number of credits display 68 are displayed. On the result history display 65, the result of the winning numbers in the games up to the last game are displayed in a list. (Here, one game is a series of operations from when each player bets at each of the stations 4, then the ball 27 falls in the number pocket 23 and until payout is made based on the winning number.) On the result history display 65, when one game is over, the most recent winning number is added from the top and displayed, and thereby the history of the winning numbers up to 16 games can be confirmed.

In addition, the denomination bet button 66 is a button for betting a chip on a bet area 72 (on the grid of a number or mark, or on the line forming the grid) specified by the player. The denomination bet button 66 consists of four kinds of buttons, that is, a 1-bet button 66A, a 5-bet button 66B, a 10-bet button 66C, and a 100-bet button 66D.

The player specifies a bet position with a cursor 70 to be described later by directly touching the bet area 72 on which to bet on the screen. By touching the 1-bet button 66A in this state, the player can bet one chip. (Each time the 1-bet button 66A is touched with a finger etc., the number of bets increases in the order of “1”→“2”→“3”→ . . . .) In addition, by touching the 5-bet button 66B, five chips can be bet. (Each time the 5-bet button 66B is touched with a finger etc., the number of bets increases in the order of “5”→“10”→“15”→ . . . .) In addition, by touching the 10-bet button 66C, 10 chips can be bet. (Each time the 10-bet button 66C is touched with a finger etc., the number of bets increases in the order of “10”→“20”→“30”→ . . . .) Further, by touching the 100-bet button 66D, 100 chips can be bet. (Each time the 100-bet button 66D is touched with a finger etc., the number of bets increases in the order of “100”→“200”→“300”→ . . . .)

The payout result display 67 displays the number of bets of the player and the number of credits to be paid out for that. Here, the number of credits to be paid out subtracted by the number of bets is the number of credits newly won by the player.

The number of credits display 68 displays the number of credits currently possessed by the player. The number of credits decreases in accordance with the number of bets (one credit for one bet). However, when credits are paid out when winning, the number of credits increases by that corresponding to the amount of payout. When the number of credits possessed by the player becomes zero, the game is closed.

On the top of the betting board 60, a bet time display 69 is provided. The bet time display 69 displays a remaining time available for betting by the player. When bet acceptance starts, “20” is displayed and the number decreases one by one for each second and when the number reaches “0”, the bet acceptance is closed. In addition, when the remaining time for the player to bet is five seconds at each of the stations 4, the ball throw-in apparatus is driven and the ball 27 is thrown onto the roulette plate.

On the right side of the bet time display 69, a MEGA display 73 that displays the accumulated number of credits of the “MEGA” JP, a MAJOR display 74 that displays the accumulated number of credits of the “MAJOR” JP, and a MINI display 75 that displays the accumulated number of credits of the “MINI” JP are provided. On the MEGA display 73, the cumulative sum of 0.15% of the credits bet at all of the 12 stations 4 is displayed. On the MAJOR display 74, the cumulative sum of 0.20% of the bet credits is displayed. On the MINI display 75, the cumulative sum of 0.30% of the bet credits is displayed. The numerical values displayed on the MEGA display 73, the MAJOR display 74, and the MINI display 75 are common to all of the stations 4. In the case of winning in the JP bonus game, the number of credits of the JP that is won among the JPs displayed on each of the displays 73 to 75 is paid out. After payout is made, the initial values (200 credits for “MINI”, 5,000 credits for “MAJOR”, and 50,000 credits for “MEGA”) are displayed on the displays of the JP.

On the betting board 60, the cursor 70 indicative of the bet area 72 currently selected by the player is displayed. In addition, on the betting board 60, a chip mark 71 indicative of the number of chips already bet and the bet area 72 is displayed. The number displayed on the chip mark 71 indicates the number bet. For example, as shown in FIG. 4, the chip mark 71 of “7” placed on the grid “18” indicates that seven chips are bet on the number “18”. Incidentally, betting on only one number is called “straight bet”.

The chip mark 71 of “1” placed on the intersection point of the grids “5”, “6”, “8” and “9” indicates that one chip is bet on the four numbers “5”, “6”, “8” and “9”. Incidentally, such betting on four numbers is called “corner bet”.

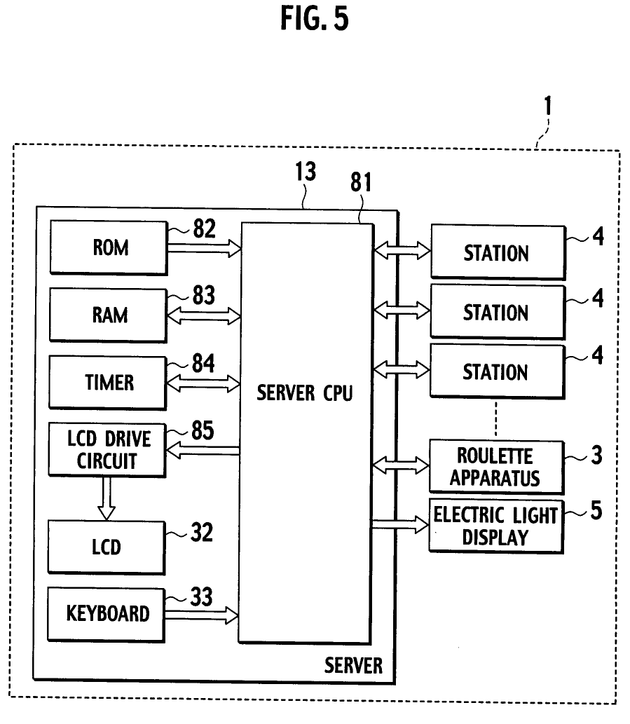

Other betting methods include “split bet” for betting on two numbers by placing a chip on the line between the two numbers, “street bet” for betting on three numbers (for example, “13”, “14” and “15”) by placing a chip on the end of the horizontal line (a line in the longitudinal direction in FIG. 4) “five bet” for betting on five numbers of “0”, “00”, “1”, “2” and “3” by placing a chip on the line between the numbers “00” and 3”, “line bet” for betting on six numbers (for example, “13”, “14”, “15”, “16”, “17” and “18”) by placing a chip between ends of two horizontal lines (two lines in the longitudinal direction in FIG. 5), “column bet” for betting on 12 numbers on the grid denoted by “2to1” and “dozen bet” for betting on successive 12 numbers by placing a chip on the grid denoted by “1st 12”, “2nd 12” or “3rd 12”.

Furthermore, there are other betting methods using six grids provided in the lowest tier of the betting board 60, such as a method for betting on the color of the number plate (“red” or “black”), a method for betting on odd or even numbers, and a method for betting on 18 numbers “1 to 18” or “19 to 36”. Here, these plural betting methods differ in the dividend of credits per chip (payout rate) when the game is won.

When betting on the bet screen 61 configured as described above, the player first specifies the bet area 72 (the grid of a number or mark, or the line forming the grid) on which to bet by directly touching the screen with a finger. As a result, the cursor 70 moves to the specified bet area 72.

After that, by touching each unit button of the denomination bet buttons 66 (the 1-bet button 66A, the 5-bet button 66B, the 10-bet button 66C, and the 100-bet button 66D), chips for the number of units are bet on the specified bet area 72. For example, when the 10-bet button 66C is touched four times, the 5-bet button 66B is touched once, and the 1-bet button 66A is touched three times, then 48 chips are bet.

FIG. 5 is a block diagram showing the internal configuration of the roulette gaming machine according to the present embodiment.

As shown in FIG. 5, the roulette gaming machine 1 includes the server 13 and a plurality of the stations 4 (12 units in the present embodiment) connected to the server 13 and the roulette apparatus 3 and the electric light display 5 (refer to FIG. 3) are connected to the server 13. By the way, the internal configuration of the roulette apparatus 3 and the internal configuration of the station 4 will be described in detail later.

The server 13 has a server CPU 81 that controls in whole, a ROM 82, a RAM 83, a timer 84, an LCD (Liquid Crystal Display) 32 connected via an LCD drive circuit 85 and a keyboard 33.

The server CPU 81 executes various kinds of processing based on input signals supplied from each of the stations 4 and data & programs stored in the ROM 82 & the RAM 83. In addition, by transmitting command signals to the stations 4 based on the processing result, the server CPU 81 controls each of the stations 4 initiatively. Further, the server CPU 81 transmits control signals to the roulette apparatus 3 and controls the launching of the ball 27 and the rotation of the roulette wheel 22.

The ROM 82 is constituted by, for example, a semiconductor memory, etc. The ROM 82 stores programs that implement basic functions of the roulette gaming machine 1, programs that execute the notification of the maintenance time and the setting & management of the notification condition, dividend rate data (the number of credits to be paid out for winning per chip) of the roulette game and programs that control each of the stations 4, etc.

In addition, the ROM 82 stores default control data 1 to 6. The default control data 1 to 6 is referred to by a CPU 101 of the roulette apparatus 3 described below, when the roulette apparatus 3 conducts rotation of the roulette wheel 22 and throw-in of the ball 27 just after activation of the roulette gaming machine 1. Therefore, the default control data 1 to 6 are also stored in a ROM 102 of the roulette apparatus 3 described below.

The RAM 83 temporarily stores the bet information supplied from each of the stations 4, the winning number of the roulette apparatus 3 determined by the sensor, the accumulated amount of JP and data about the result of the processing executed by the server CUP 81, etc.

The timer 84 for time measurement is connected to the server CPU 81. The time information of the timer 84 is transmitted to the server CPU 81 and the server CPU 81 controls the rotation of the roulette wheel 22 and the thrown-in of the ball 27 to be described later based on the time information of the timer 84.

Additionally, the electric light display 5 (see FIG. 3) is connected to the server CPU 81. The electric light display 5 controls light emission of LEDs to provide the effect of electric decoration. Further, the server CPU 81 displays predetermined letters on the electric light display 5. Furthermore, the server CPU 81 displays the accumulated amount of JP (the “MEGA” JP in the present embodiment) on the JP amount display 15 of the electric light display 5.

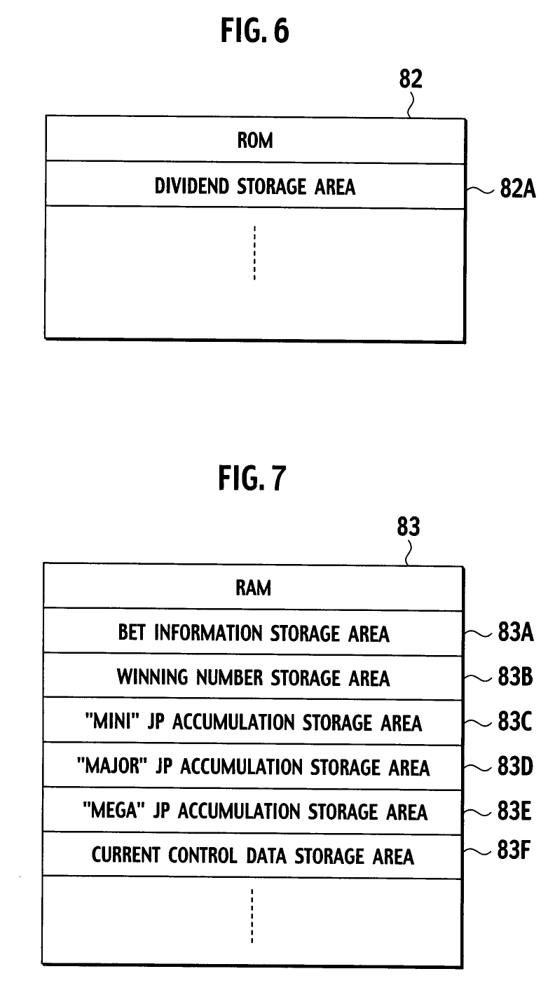

FIG. 6 is a schematic diagram showing the storage area of the ROM 82 of the roulette gaming machine 1 according to the present embodiment.

As shown in FIG. 6, the ROM 82 has a dividend storage area 82A storing the dividend rate relating to the game. Incidentally, the dividend rate for each bet area 72 stored in the dividend storage area 82A is determined in advance as “×2” to “×36” depending on the kind of betting (“straight bet”, “corner bet”, “split bet”, etc.).

FIG. 7 is a schematic diagram showing the storage area of the RAM 83 of the roulette gaming machine 1 according to the present embodiment.

As shown in FIG. 7, the RAM 83 has abet information storage area 83A storing the bet information of the player now playing the game, a winning number storage area 83B storing the winning number of the roulette apparatus 3 determined by the ball sensor 105, a “MINI” JP accumulation storage area 83C storing the number of accumulated credits of the “MINI” JP, a “MAJOR” JP accumulation storage area 83D storing the number of accumulated credits of the “MAJOR” JP, a “MEGA” JP accumulation storage area 83E storing the number of accumulated credits of the “MEGA” JP and a current control data storage area 83F for storing current control data 1 to 6 provided therein. Specifically, the bet information is information about the bet area 72 specified on the bet screen 61 (refer to FIG. 5), the number of bet chips (number of bets) and the betting at the station 4 such as the kind of betting etc.

FIG. 8 is a block diagram showing the internal configuration of the roulette apparatus 3 according to the present embodiment.

As shown in FIG. 8, the roulette apparatus 3 includes a controller 109, the pocket position detecting circuit 107, the ball throw-in apparatus 104, the ball sensor 105, the wheel drive motor 106 and a ball collecting apparatus 108. The controller 109 is equivalent to the controller in the present invention.

The controller 109 has a CPU 101, a ROM 102 and a RAM 103. The CPU 101 controls the launching of the ball 27 and the rotation of the roulette wheel 22 based on control signals supplied from the server 13 and data & programs stored in the ROM 102 & the RAM 103.

FIG. 9 is a schematic diagram showing the storage area of the ROM 102 of the roulette apparatus 3 according to the present embodiment.

As shown in FIG. 9, the ROM 102 has control data storage areas 102A to 102F and stores the control data 1 to 6 shown in FIG. 2. Additionally, as with the ROM 82 of the server 13, default control data 1 to 6 is stored in the ROM 102 and referred to when the roulette apparatus 3 conducts rotation of the roulette wheel 2 and launch of the ball 27 just after the roulette gaming machine 1 has been activated.

The pocket position detecting circuit 107 has a proximity sensor. The pocket position detecting circuit 107 detects the position of the roulette wheel 22 by detecting the metal plates attached to the roulette wheel 22.

The ball throw-in apparatus 104 throws in the ball 27 onto the roulette wheel 22 from the ball throw-in opening 36 (refer to FIG. 1). The ball throw-in apparatus 104 throws in the ball 27 at the initial velocity set in the control data. In addition, the ball throw-in apparatus 104 throws in the ball 27 with timing based on the launching delay time set in the control data. In other words, the ball 27 is thrown in when the launching delay time elapses after the pocket position detecting circuit 107 detects that the predetermined number pocket 23 (for example, “00”) has passed by a predetermined position (for example, in front of the ball throw-in opening 36).

The ball sensor 105 detects which number pocket 23 has received the ball 27. The wheel drive motor 106 rotates the roulette wheel 22. The wheel drive motor 106 stops driving when the motor drive time set in the control data elapses from the rotating start. The ball collecting apparatus 108 collects the ball 27 on the roulette wheel 22 after the game is over.

FIG. 10 is a block diagram showing the internal configuration of the station 4 according to the present embodiment. By the way, the stations 4 provided in 12 units have basically the same configuration and then one of the stations 14 will be described below as an example.

As shown in FIG. 10, the station 4 includes a station controller 90 constituted by a station CPU 91, a ROM 92 and a RAM 93. The ROM 92 is constituted, for example, by a semiconductor memory. The ROM 92 stores programs that implement basic functions of the station 4, various programs necessary for the control of the rest of the stations 4, data tables and so on. In addition, the RAM 93 temporarily stores various data operated by the station CPU 91, the number of credits possessed by the player (saved at the station 4), the state of betting by the player and so on.

In addition, a bet confirming button 47, a payout button 48 and a help button 49 provided on the console 7 (refer to FIG. 3) are connected to the station CPU 91, respectively.

The bet confirming button 47 is pressed down by the player when confirming the bet after the betting operation on the display panel 8. The payout button 48 is pressed down by the player normally when the game is over. When the payout button 48 is pressed down, medals in accordance with the credits possessed by the player (normally, one medal for one credit) are paid out from the medal payout opening 9. The help button 49 is pressed down by the player when the operation method of the game is unclear. When the help button 49 is pressed down, a help screen showing various kinds of operation information is displayed on the display panel 8.

Based on operational signals which are output from the console 7 by the player's pressing down the bet confirming button 47, the payout button 48 or the help button 49, the station CPU 91 controls execution of a variety of corresponding operations. Specifically, the station CPU 91 executes various processes based on input signals provided to the station CPU 91 from the console 7 in response to the player's operation of the bet confirming button 47, the payout button 48 or the help button 49, and the data & programs stored in the ROM 92 & RAM 93. The station CPU 91 then transmits the result of processing to the server CPU 81.

In addition, the station CPU 91 receives the command signal from the server CPU 81 and advances the game by controlling the peripheral devices constituting the station 4. The station CPU 91 executes various kinds of processing in accordance with the contents of the processing based on the input signal supplied from the console 7 by the player's operation and the data & programs stored in the ROM 92 & the RAM 93. The station CPU 91 advances the game by controlling the peripheral devices constituting the station 4 based on the processing result.

Further, a hopper 94 is connected to the station CPU 91. The hopper 94 pays out a predetermined number of medals from the medal payout opening 9 (refer to FIG. 3) by the command signal from the station CPU 91.

Furthermore, the display panel 8 is connected to the station CPU 91 via an LCD drive circuit 95. The LCD drive circuit 95 includes a program ROM, an image ROM, an image control CPU, a work RAM, a VDP (video display processor) and a video RAM. The program ROM stores an image control program relating to display on the display panel 8 and various selection tables. The image ROM stores, for example, dot data for forming images to be displayed on the display panel 8. According to the image control program in the program ROM, the image control CPU determines, from among the dot data in the image ROM, the image to be displayed on the display panel 8, based on parameters set by the station CPU 91. The work RAM temporarily stores the image control program when executing the same by the image control CPU. The VDP forms and outputs to the display panel 8 the display image determined by the image control CPU. Here, the video RAM functions as a temporary storage device when forming an image by the VDP.

In addition, to the front of the display panel 8, the touch screen 50 is attached as described above. The operation information on the touch screen 50 by the player is transmitted to the station CPU 91. On the touch screen 50, the player's betting operation is performed. Specifically, the operation of the touch screen 50 (such as the selection of the bet area 72 and the operation of the unit bet buttons 66) is performed. When the touch screen 50 is operated by the player, its operative information is transmitted to the station CPU 91. Then, the bet information (the bet area specified on the bet screen 61 and the number of bet) of the current player is constantly stored in the RAM 93 based on the information. Further, the bet information is transmitted to the server CPU 81 and stored in the bet information storage area of the RAM 83.

Furthermore, a sound output circuit 96 and the speaker 10 are connected to the station CPU 91. The speaker 10 generates various kinds of effect sounds when executing various effects based on the output signal from the sound output circuit 96.

In addition, the medal sensor 97 is connected to the station CPU 91. The medal sensor 97 detects a medal inserted through the medal insertion slot 6 (refer to FIG. 3). At the same time, the medal sensor 97 counts the inserted medals and transmits the result to the station CPU 91. The station CPU 91 increases the number of credits of the player stored in the RAM 93 based on the transmitted signal.

In addition, the WIN lamps 11 are connected to the station CPU 91. The station CPU 91 lights up the WIN lamp 11 in a predetermined color when the betting on the bet screen 61 is won or when the JP is won.

Subsequently, the game processing of the server, the game processing of the station and the game processing of the roulette in the roulette gaming machine 1 according to the present embodiment will be described referring to FIGS. 11 to 13. The game processing of the server is executed by the server CPU 81 according to the program stored in the ROM 82. The game processing of the station is executed by the station CPU 91 according to the program stored in the ROM 92. The game processing of the roulette is executed by the CPU 101 according to the program stored in the ROM 102. FIGS. 11 to 13 are flowcharts illustrating the game processing of the roulette gaming machine according to the present embodiment.

First, the game processing of the station will be described based on FIGS. 11 to 13.

First, as shown in FIG. 11, the station CPU 91 determines whether or not the player has inserted one or more medals or coins based on the detection signal of the medal sensor 97 (step S11). When no medal or coin is inserted (NO in step S11), the process flow waits for insertion. When, on the other hand, one or more medals or coins are inserted (YES in step S11), the process flow proceeds to step S12.

The station CPU 91 records credit data into the RAM 93 according to the number of medals or coins inserted (step S12). Next, the station CPU 91 transmits a medal detection signal to the server 13 (step S13).

Next, the station CPU 91 displays the bet screen 61 shown in FIG. 4 on the display panel 8 of the station 4 (step S14). Next, the station CPU 91 starts to measure the betting time during allowable for betting (step S15).

Then the player can bet on the bet area 72 that he/she expects to win by operating the touch screen 50 during the betting time (see FIG. 4). Here, since a specific betting type on the bet screen 61 has already been described, further description will be omitted.

In addition, the player can also participate in the game after the betting time has already been started. With the roulette gaming machine 1 according to the present embodiment, a maximum of 12 people can play the game. Furthermore, acceptance of the betting operation is started immediately after the previous game is finished, in a case where the next game is played subsequent to the previous game.

Next, the station CPU 91 receives a betting time expiration signal indicating the end of the betting time from the server CPU 81 (step S16). An image indicating the end of the betting time is displayed on the display panel 8 and acceptance of the betting operation via the touch screen 50 is terminated (step S17). Subsequently, the station CPU 91 transmits the player's bet information (specified bet area 72, number of bets, or type of bet) to the server CPU 81 (step S18).

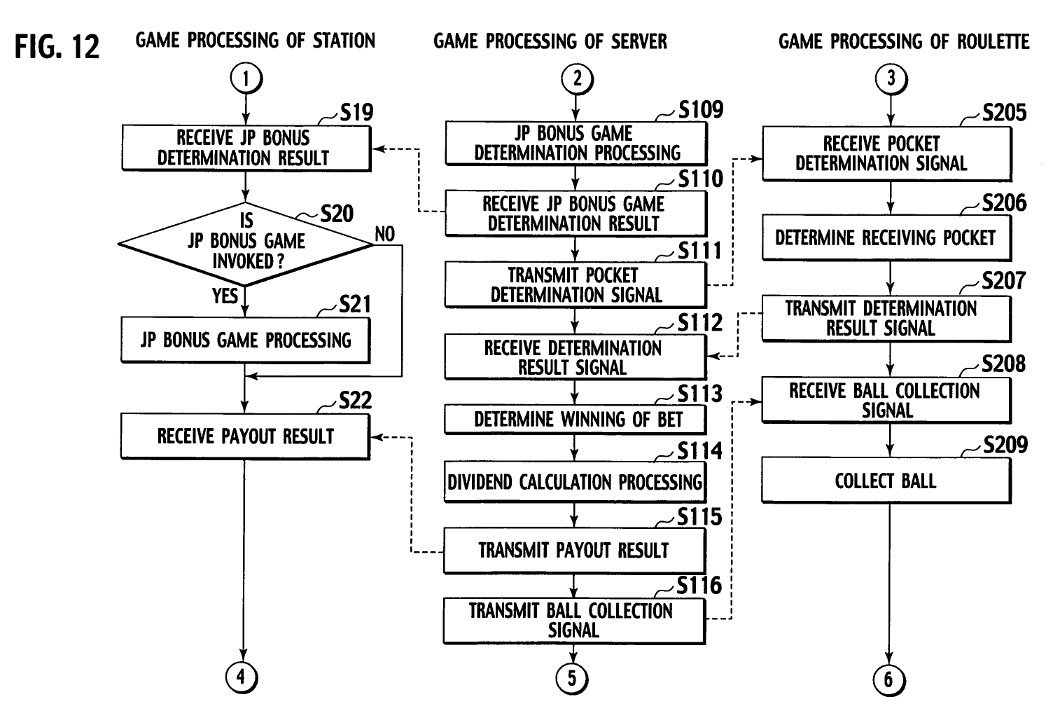

Next, the station CPU 91 receives the result of the JP bonus game determination processing from the server CPU 81 (step S19). The JP bonus game determination processing is executed by the server CPU 81 as shown in FIG. 12 and described below. The determination result of JP bonus game includes whether or not to execute a predetermined JP bonus game in respective stations 4. Further, the determination result includes which of the stations 4 is to win the JP (or all of the stations 4 are to lose) when the JP bonus game is executed. Furthermore, the determination result includes which one of the JPs (“MEGA”, “MAJOR” or “MINI”) is to be won when the JP is won.

Next, the station CPU 91 determines whether or not to execute the JP bonus game based on the result of the JP bonus game determination processing received in step S19 (step S20). When it is determined that the JP bonus game will be executed on the station 4, a predetermined selection-type JP bonus game is executed. The result of the game (whether or not the JP has been hit) is displayed on the display panel 8 based on the determination result received in step S19.

When it is determined in step S20 that the bonus game will not be executed on the station 4 or after the process of step S21, the station CPU 91 receives the payout result of credit transmitted from the server CPU 81 (step S22). The payout result of credit is composed of the payout result from the base game and the JP payout result from the JP bonus game.

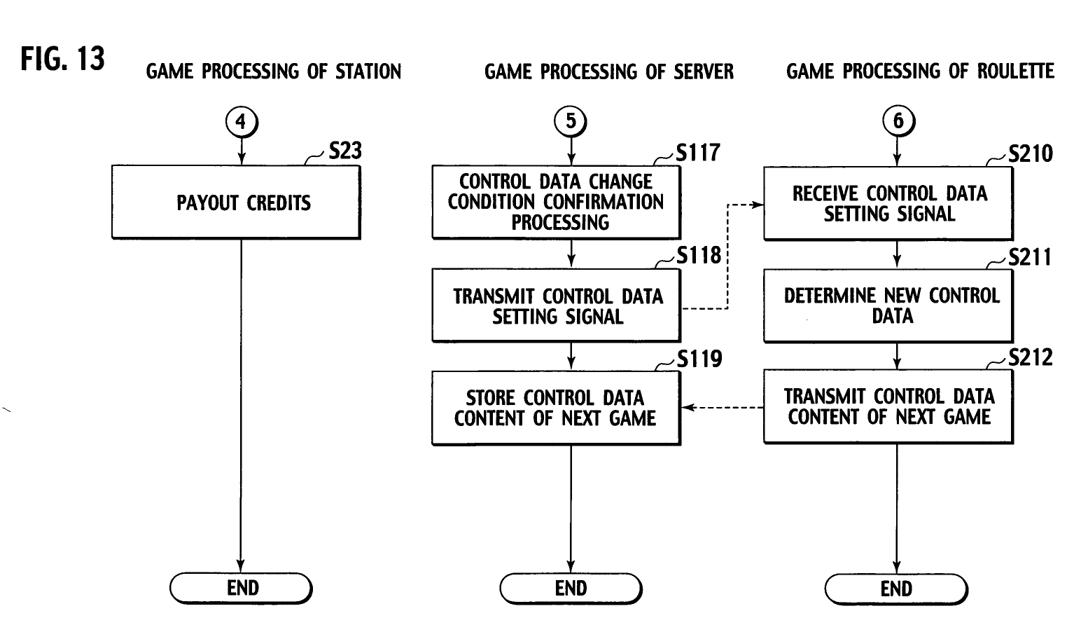

Next, in step S23, the station CPU 91 executes payout of credits based on the payout result received in step S22, as shown in FIG. 13. Specifically, credit data corresponding to the game dividend and credit data corresponding to the accumulated JP dividend with the winning of the JP bonus game are stored in the RAM 93, respectively. Then, medals according to the number of credits (typically one medal per credit) stored in the RAM 93 are paid out from the medal payout opening 9 when the payout button 48 is pressed down.

Subsequently, when the game is supposed to be continued on any of the stations 4, the process flow returns to step S14 to start the betting time again and proceeds to the next game. When, on the other hand, the game is supposed to be terminated on all of the stations 4, the game processing is terminated.

Next, the game processing of the server will be described referring to FIGS. 11 to 13.

First, the server CPU 81 receives the medal detection signal from the station CPU 91 (step 101) and determines whether or not one or more medals or coins are inserted by the player, as shown in FIG. 11. With the roulette gaming machine 1 according to the present embodiment, the medal detection signal is transmitted to the server CPU 81 from the station CPU 91 of the station 4 when one or more medals or coins are inserted at any one of the stations 4.

Next, the server CPU 81 starts to measure the betting time from the time point when the first player inserted one or more medals or coins (step S102). The betting time is a period during which the input of betting is possible. The player who has participated in the game can bet on the bet area 72 that he/she expects to win, by operating the touch screen 50 during the betting time.

Next, the server CPU 81 determines whether or not there are five seconds left of the betting time (step S103). The remaining betting time is displayed on the bet time display 69 (see FIG. 4). If it is determined that the remaining time is longer than five seconds, the process flow returns to step S103. If, otherwise, if it is determined that the remaining time is five seconds, the process flow proceeds to step S104.

The server CPU 81 transmits, to the CPU 101, a control signal to start operation of the roulette apparatus 3 (step S104). Next, the server CPU 81 determines whether or not the betting time has expired (step S105). If it is determined that the betting time has not expired, it waits until the betting time is expired. If, on the other hand, it is determined that the betting time has expired, the server CPU 81 transmits a betting time expiration signal to the station CPU 91 (step S106).

Next, the server CPU 81 receives bet information (specified bet area 72, number of bets, type of bet) at the stations 4 from the station CPU 91 (step S107) and stores the information in the bet information storage area 83A of the RAM 83.

Next, the server CPU 81 executes the JP accumulation processing (step S108). In the JP accumulation processing, 0.30% of the total credits received in step S107, which have been bet in the stations 4, is added to the amount recorded in the accumulated “MINI” JP storage area 83C of the RAM 83. Additionally, in the JP accumulation processing, 0.20% of the total credits received in step S107, which have been bet in respective stations 4, is added to the amount recorded in the accumulated “MAJOR” JP storage area 83D of the RAM 83. Furthermore, 0.15% of the total credits is added in the amount recorded in the accumulated “MEGA” JP storage area 83E of the RAM 83. Also, in the JP accumulation processing, presentations on the JP amount display 15, the MEGA display 73, the MAJOR display 74, and the MINI display 75 are updated based on the amount of JP after the addition.

Next, as shown in FIG. 12, the server CPU 81 executes the JP bonus game determination processing (step S109). In this processing, the server CPU 81 determines whether or not to execute the JP bonus game on respective stations 4, using a random number value sampled in a sampling circuit or the like. When executing the JP bonus game, it is also determined which of the stations 4 is supposed to win a JP (or all of the stations 4 will lose). Furthermore, it is also determined which of the JPs (“MEGA”, “MAJOR”, or “MINI”) is supposed to be won.

Next, the server CPU 81 transmits the determination result of the JP bonus game to respective stations 4 based on the process of step S109 (step S110). The server CPU 81 transmits a control signal to the CPU 101 (step S111), thereby causing the CPU 101 to determine which of the number pockets 23 of the roulette apparatus 3 has received the ball 27. The server CPU 81 then receives the control signal indicating the determination result from the CPU 101 (step S112).

Next, the server CPU 81 determines whether or not the bets on respective stations 4 are won based on the bet information of respective stations 4 received in step S107 and the control signal indicating the determination result of the number pockets 23 received in step S112 (step S113).

Next, the server CPU 81 executes the dividend calculation processing (step S114). In the dividend calculation processing, the number of winning bets is recognized for each of the stations 4. Based on the dividend rate (number of credits to be paid out per bet) stored in the dividend storage area 82A of the ROM 82, the total amount of dividend of the credits to be paid out is calculated for each of the stations 4.

Next, the server CPU 81 executes transmission processing of the credit payout result based on the dividend calculation processing of step S114 and the JP payout result based on the JP bonus game determination processing of step S109 (step S115). Specifically, credit data corresponding to the amount of dividend is output to the station CPU 91 of the winning station 4. In addition, credit data corresponding to the amount of accumulated JP is further output to the station CPU 91 of the JP-winning station 4. Next, the server CPU 81 transmits a collection signal of the ball 27 to the CPU 101 (step S116).

Next, as shown in FIG. 13, the server CPU 81 confirms whether or not change condition of the control data 1 to 6 is met (step S117). In the determination processing of the control data change condition, the server CPU 81 executes, specifically, summation of the number of bets and determination of bias in the number of bets.

Of these, in the summation of the number of bets, the server CPU 81 uses one of the default control data 1 to 6 stored in the ROM 82, and the current control data 1 to 6 stored in the currently-used control data storage area 83F of the RAM 83.

Specifically, the server CPU 81 uses, for summating the number of bets, the default control data 1 to 6 stored in the ROM 82, if rotation of the roulette wheel 22 and throw-in of the ball 27 are performed immediately after activation of the roulette gaming machine 1. Otherwise, the server CPU 81 uses, for summating the number of bets, the current control data 1 to 6 stored in the currently-used control data storage area 83F of the RAM 83.

Then, the server CPU 81 identifies, for summating the number of bets, one of the areas A to F of the roulette wheel 22 based on the default control data 1 to 6 or the current control data 1 to 6. The single area among A to F identified here is the area having a higher probability of receiving the ball 27 assigned by the current control data 1 to 6.

Additionally, in the summation processing of the number of bets, the server CPU 81 summates the number of bets on the number pocket 23 within the identified one of the areas A to F.

In the summation processing of the number of bets, the server CPU 81 uses the bet information (number of bets in the specified bet area 72) received from the station CPU 91 in step S107. In other words, the server CPU 81 identifies the bet number pocket 23 based on the bet area 72 in the bet information received in step S107, and summates the total number of bets on the bet number pocket 23 in the previously identified one of the areas A to F.

Next, the server CPU 81 determines, in the number of bet bias determination processing, whether or not the total number of bets summated in the summation processing of the number of bets has reached a predetermined threshold value.

Here, the predetermined threshold value is set as a condition for determining whether or not it is necessary to change the current control data 1 to 6. Therefore, the predetermined threshold value is set as a value by which it can be considered that bets are concentrated on the specific area A to F provided with higher probability of receiving the ball 27 by the current control data 1 to 6.

After the control data change condition determination processing is executed in step S117 by the above-mentioned processing of summating the number of bets and confirmining bias of the number of bets, the server CPU 81 transmits a control signal requesting to set the control data 1 to 6 to be used in the next game to the CPU 101 (step S118).

Here, the server CPU 81 transmits a control signal indicating that the change condition of the control data is met to the CPU 101, if it is determined that the total number of bets summated in the control data change condition identification processing of step S117 has reached a predetermined threshold value. Otherwise, the server CPU 81 transmits a control signal indicating that the change condition of the control data is not met to the CPU 101, if the total number of bets summated in the control data change condition determination processing of step S117 has not reached a predetermined threshold value.

Next, the server CPU 81 receives a control signal indicating the control data 1 to 6 to be used in the next game from the CPU 101 and stores it in the RAM 83 (step S119). This subroutine is finished subsequent to the processing of step S119.

Next, the game processing of the roulette will be described referring to FIGS. 11 to 13.

First, as shown in FIG. 11, the CPU 101 receives a control signal for starting operation of the roulette apparatus 3 from the server CPU 81 (step S201).

Next, the CPU 101 controls the following operations, referring to the one which is currently selected among the control data 1 to 6 stored in the control data storage areas 102A to 102F of the ROM 102.

First, the CPU 101 drives the wheel drive motor 106 for a motor drive time set in the current control data 1 to 6 to rotate the roulette wheel 22 (step S202).

Next, if a predetermined time period (e.g., 20 seconds) has elapsed (YES in step S203), the CPU 101 throws in the ball 27 after the launching delay time elapsed (step S204), based on the detection signal from the pocket position detecting circuit 107. In this occasion, the CPU 101 throws in the ball at an initial velocity which is set in the current control data 1 to 6.

By the way, the CPU 101 refers to one of the control data 1 to 6 set as default, among the control data 1 to 6 stored in the control data storage areas 102A to 102F of the ROM 102, when processing steps S202 and S204 for the first time immediately after activation of the roulette gaming machine 1.

Next, as shown in FIG. 12, the CPU 101 receives the pocket determination signal transmitted from the server CPU 81 (step S205). Subsequently, the CPU 101 drives the ball sensor 105 and determines which of the number pockets 23 received the ball 27 (step S206). The CPU 101 then transmits, to the server CPU 81, a signal indicating the determination result of the number pocket 23 which has received the ball 27 (step S207).

Next, the CPU 101 receives the ball collection signal transmitted from the server CPU 81 (step S208). Subsequently, the CPU 101 drives the ball collecting apparatus 108 provided at the lower part of the roulette wheel 22 and collects the ball 27 on the roulette wheel 22 (step S209). The collected ball 27 is thrown into the roulette wheel 22 again in the next game by the ball throw-in apparatus 104.

Next, as shown in FIG. 13, the CPU 101 receives the control data setting signal transmitted from the server CPU 81 (step S210). The CPU 101 then determines the control data 1 to 6 to be used in the next game, according to the received control data setting signal (step S211).

Here, when the control data setting signal received in step S210 indicates that the control data change condition is met, the CPU 101 determines that change of the control data 1 to 6 is required, and specifies control data 1 to 6 which are different from the current control data 1 to 6 as the control data 1 to 6 to be used in the next game. The CPU 101 determines the control data 1 to 6 to be used in the next game using the random number value sampled in a sampling circuit or the like.

On the other hand, when the control data setting signal received in step S210 indicates that the control data change condition is been met, the CPU 101 determines that no change of the control data 1 to 6 is required and that the current control data 1 to 6 are also used in the next game without change.

The CPU 101 then transmits, to the server CPU 81, the control signal indicating the control data 1 to 6 to be used in the next game determined in step S211 (step S212). This subroutine is finished after the process of step S212.

Incidentally, each of the processings of steps S117 to S119 in FIG. 13 may be executed anytime after the bet information is received from the station CPU 91 by the server CPU 81 in step S107 of FIG. 11.

In addition, each of the processings of steps S210 to S212 in FIG. 13 may be executed prior to step S209 of FIG. 12 provided that it is after reception of the setting signal of the control data 1 to 6 transmitted from server CPU 81. However, the timing of executing the respective processings of steps S210 to S212 in FIG. 13 must be synchronized with the timing at which the server CPU 81 transmits the setting signal of the control data 1 to 6.

As thus described, the roulette gaming machine 1 according to the first embodiment of the present invention includes a roulette wheel 22 having a plurality of number pockets 23, each of which being associated with a number. In the roulette wheel 22, every six or seven pockets of the number pockets 23 are grouped into one of the pocket groups 24A to 24F. The respective pocket groups 24A to 24F have corresponding areas A to F arranged on the roulette wheel 22, respectively.

In addition, the roulette gaming machine 1 according to the first embodiment uses one of the control data 1 to 6 among the control data 1 to 6 stored in the ROM 102 of the roulette apparatus 3 for rotation of the roulette wheel 22 and throw-in of the ball 27. Each of control data 1 to 6 raises the probability of receiving the ball 27 into one of the areas A to F on the roulette wheel 22 higher than that in the others of the areas A to F.

Then, if, in each game, the number pocket 23 bet by the players is concentrated on a specific one of the areas A to F having a higher probability of receiving the ball 27 according to the current control data 1 to 6, the roulette gaming machine 1 according to the first embodiment changes the control data 1 to 6 to be used in the next game.

Therefore, with the roulette gaming machine 1 according to the first embodiment, entertainment of the game can be enhanced by intentionally biasing the number pocket 23 which is supposed to receive the ball 27 within a specific one of the areas A to F, by controlling rotation of the roulette wheel 22 and throw-in of the ball 27 using the control data 1 to 6.

Moreover, with the roulette gaming machine 1 according to the first embodiment, if betting is concentrated on one of the areas A to F having the probability of receiving the ball 27 intentionally biased, the specific one of areas A to F having a higher probability of receiving the ball 27 is changed in the next game based on another control data 1 to 6. Therefore, the difficulty of predicting the number pocket 23 which is supposed to receive the ball 27 is preserved, whereby entertainment of the game can be enhanced.

Note that, with the roulette gaming machine 1 according to the first embodiment, rotation of the roulette wheel 22 and throw-in of the ball 27 are executed prior to expiration of the betting time. Therefore, summation of the number of bets and determination of change condition are necessarily executed after rotation of the roulette wheel 22 and throw-in of the ball 27 has been executed. Thus, with the roulette gaming machine 1 according to the first embodiment, changing the control data 1 to 6 based on the change condition of the control data 1 to 6 is reflected in the next game.

However, if rotation of the roulette wheel 22 and throw-in of the ball 27 are arranged to be executed after the betting time expired, summation of the number of bets and determination of change condition can be done before executing rotation of the roulette wheel 22 and throw-in of the ball 27. Therefore, changing the control data 1 to 6 based on the change condition can be reflected in the current game.

In the following, a roulette gaming machine according to the second embodiment of the present invention in this context will be described.

The roulette gaming machine according to the second embodiment of the present invention includes a hardware configuration essentially similar to that of the roulette gaming machine 1 of the first embodiment. Therefore, the external appearance and the basic internal configuration of the roulette gaming machine according to the second embodiment will be described referring to FIGS. 1 to 10 again, thereby omitting duplicated description.

Thus, with the roulette gaming machine 1 according to the second embodiment, the default control data 1 to 6 stored in the ROM 82 of the server 13 or the ROM 102 of the roulette apparatus 3 are slightly different from the control data 1 to 6 of the first embodiment.

In other words, with the second embodiment, the default control data 1 to 6 stored in the ROM 82 of the server 13 or the ROM 102 of the roulette apparatus 3 are provided as candidates to which the CPU 101 first refers when rotation of the roulette wheel 22 and throw-in of the ball 27 are executed immediately after activation of the roulette gaming machine 1.

In addition, the roulette gaming machine 1 according to the second embodiment is different from the roulette gaming machine 1 of the first embodiment, partially in the game processing of the server, the game processing of the station and the game processing of the roulette.

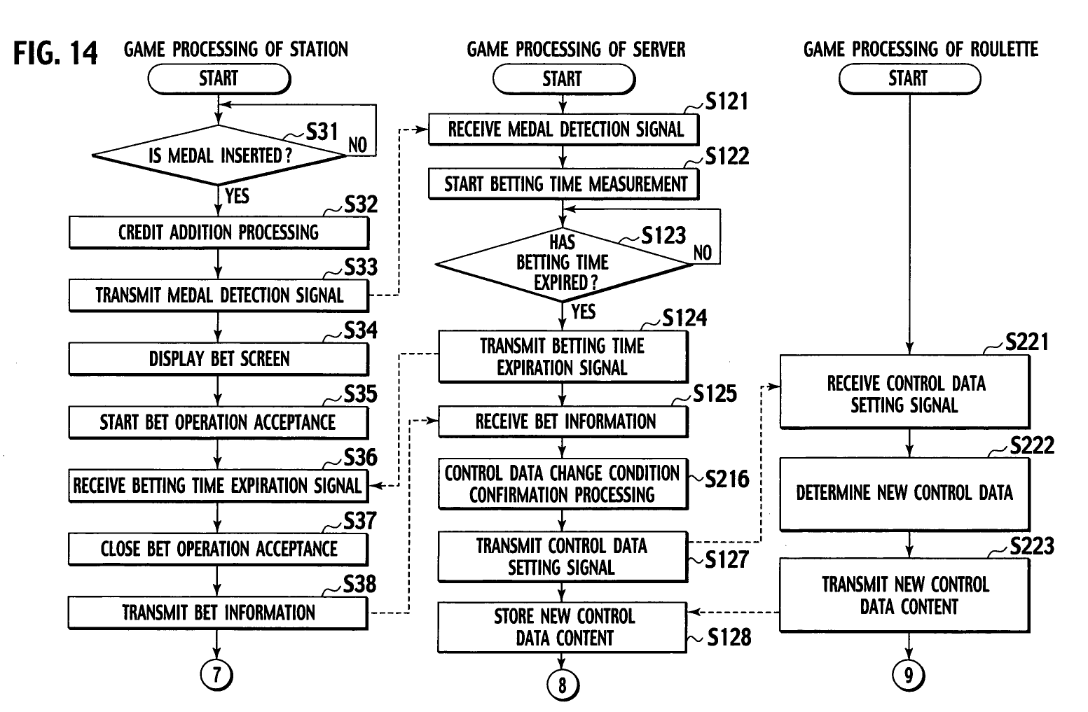

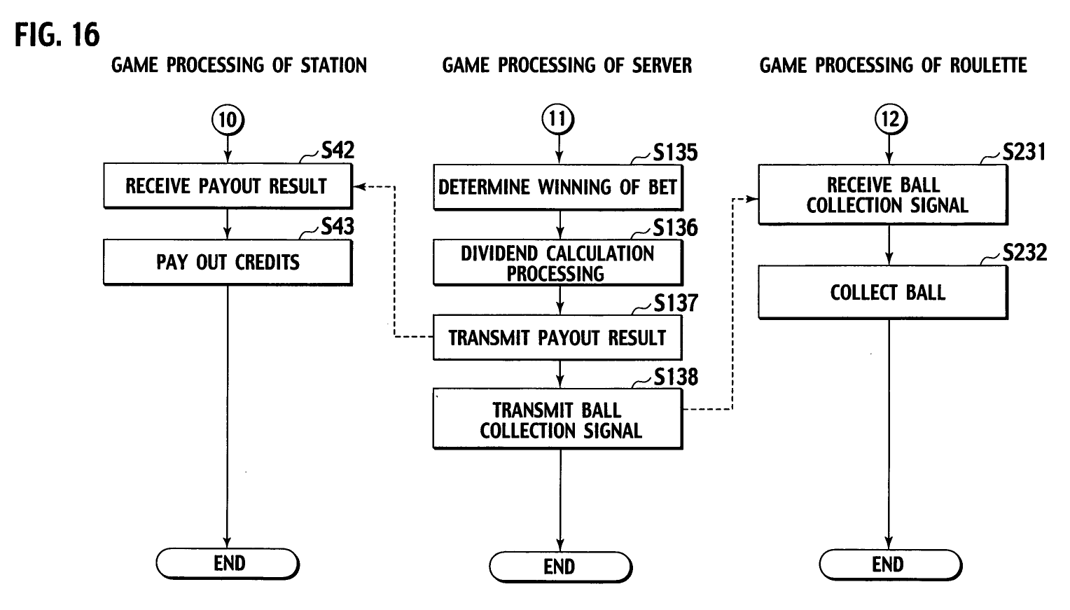

In the following, the partial difference of the roulette gaming machine 1 according to the second embodiment from the first embodiment of the game processing of the server, the game processing of the station and the game processing of the roulette will be described, referring to FIGS. 14 to 16. Incidentally, the game processing of the server is executed by the server CPU 81 according to the program stored in the ROM 82. The game processing of the station is executed by the station CPU 91 according to the program stored in the ROM 92. The game processing of the roulette is executed by the CPU 101 according to the program stored in the ROM 102. FIGS. 14 to 16 are flowcharts illustrating the game processing of the roulette gaming machine according to the present embodiment.

First, the game processing of the station will be described referring to FIGS. 14 to 16.

The station CPU 91 of the roulette gaming machine 1 according to the second embodiment executes respective processings of steps S31 to S43 of FIGS. 14 to 16 according to the program stored in the ROM 92. The respective processings of steps S31 to S43 are completely identical to those of steps S11 to S23 of FIGS. 11 to 13. Therefore, the game processing of the station of the roulette gaming machine 1 according to the second embodiment is completely identical to that of the roulette gaming machine 1 according to the first embodiment.

Next, the game processing of the server will be described referring to FIGS. 14 to 16.

First, as shown in FIG. 14, the server CPU 81 receives the medal detection signal from the station CPU 91 (step S121) and determines whether or not one or more medals or coins are inserted by the player, similarly to step S101 of FIG. 11.

Next, the server CPU 81 starts to measure the betting time from the time point when the first player inserted one or more medals or coins (step S122), similarly to step S102 of FIG. 11. Next, the server CPU 81 determines whether or not the betting time has expired (step S123), similarly to step S105 of FIG. 11. If it is determined that the betting time has not expired, it waits until the betting time is expired. If, on the other hand, it is determined that the betting time has expired, the server CPU 81 transmits a betting time expiration signal to the station CPU 91 (step S124), similarly to step S106 of FIG. 11.

Next, the server CPU 81 receives bet information (specified bet area 72, number of bets, type of bet) at the stations 4 from the station CPU 91 (step S125) and stores the information in the bet information storage area 83A of the RAM 83, similarly to step S107 of FIG. 11.

Next, the server CPU 81 determines whether or not change condition of the control data 1 to 6 is met (step S126). In the determination processing of control data change condition, the server CPU 81 executes, specifically, summation of the number of bets and determination of bias in the number of bets, similarly to step S117 of FIG. 13.

Of these, in the summation of the number of bets, the server CPU 81 uses one of the default control data 1 to 6 stored in the ROM 82, and the current control data 1 to 6 stored in the currently-used control data storage area 83F of the RAM 83.

Specifically, the server CPU 81 uses, for summation of the number of bets, the default control data 1 to 6 stored in the ROM 82, if it is immediately after expiration of the first betting time just after activation of the roulette gaming machine 1. Otherwise, the server CPU 81 uses, for summation of the number of bets, the control data 1 to 6 used in the previous game, which is stored in the currently-used control data storage area 83F of the RAM 83.

Then, the server CPU 81 identifies, for summation of the number of bets, one of the areas A to F of the roulette wheel 22 based on the default control data 1 to 6 or the control data 1 to 6 used in the previous game. The single area among A to F identified here is the area having a higher probability of receiving the ball 27 assigned by the previous control data 1 to 6.

Additionally, in the summation process of the number of bets, the server CPU 81 summates the number of bets on the number pocket 23 within the identified one of the areas A to F.

In the summation process of the number of bets, the server CPU 81 uses the bet information (number of bets in the specified bet area 72) from the station CPU 91 in step S125. In other words, the server CPU 81 identifies the number pocket 23 which has been bet, based on the bet area 72 in the bet information received in step S125, and summates the total number of bets on the number pocket 23 in the previously identified one of the areas A to F.

Next, the server CPU 81 determines, in the number of bet bias determination processing, whether or not the total number of bets summated in the summation process of the number of bets has reached a predetermined threshold value.

Here, the predetermined threshold value is set as a condition for determining whether or not it is necessary to change the previous control data 1 to 6. Therefore, the predetermined threshold value is set as a value by which it can be considered that bets are concentrated on specific areas A to F provided with a higher probability of receiving the ball 27 by the previous control data 1 to 6.

After the control data change condition determination processing is executed in step S126 by the above-mentioned processings of summating the number of bets and determining bias of the number of bets, the server CPU 81 transmits, to the CPU 101, a control signal requesting to set the control data 1 to 6 to be used in the current game (step S127).

Here, the server CPU 81 transmits a control signal indicating that the change condition of the control data is met to the CPU 101, if it is determined that the total number of bets summated in the control data change condition identification processing of step S126 has reached a predetermined threshold value. Otherwise, the server CPU 81 transmits a control signal indicating that the change condition of the control data is not met to the CPU 101, if the total number of bets summated in the control data change condition determination processing of step S126 has not reached a predetermined threshold value.

Next, the server CPU 81 receives a control signal indicating the control data 1 to 6 to be used in the next game from the CPU 101 and stores it in the RAM 83 (step S128).

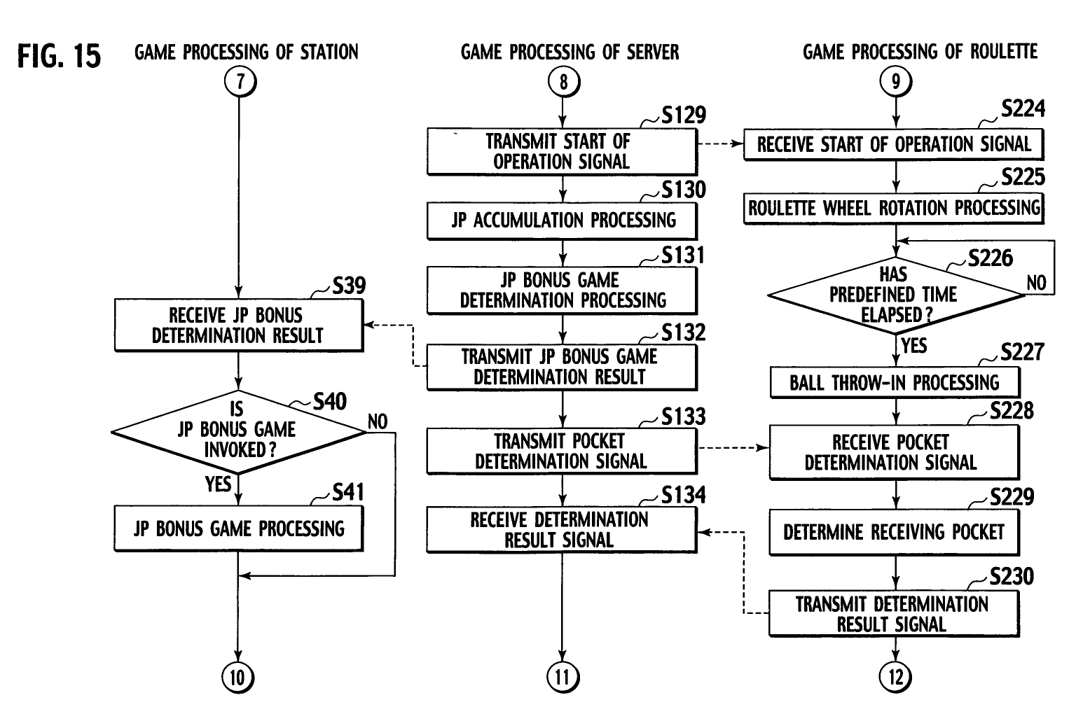

Next, the server CPU 81 transmits a control signal to start operation of the roulette apparatus 3 to the CPU 101 as shown in FIG. 15 (step S129), similarly to step S104 of FIG. 11. Next the server CPU 81 executes the JP accumulation processing (step S130), similarly to step S108 of FIG. 11.

Next, the server CPU 81 executes the JP bonus game determination processing (step S131), similarly to step S109 of FIG. 12. Subsequently, the server CPU 81 transmits the determination result of the JP bonus game to respective stations 4 based on the processing of step S131 (step S132), similarly to step S110 of FIG. 12. Next, the server CPU 81 transmits a control signal to the CPU 101 (step S133), similarly to step S111 of FIG. 12, thereby causing the CPU 101 to determine which of the number pockets 23 of the roulette apparatus 3 has received the ball 27. The server CPU 81 then receives a control signal indicating the determination result from the CPU 101 (step S134), similarly to step S112 of FIG. 12.

Next, the server CPU 81 determines whether or not the bets on respective stations 4 are won, based on the bet information of respective stations 4 received in step S125 and the control signal indicating the determination result of the number pockets 23 received in step S134 (step S135), similarly to step S113 of FIG. 13.

Next, the server CPU 81 executes the dividend calculation processing (step S136), similarly to step S114 of FIG. 13. Subsequently, the server CPU 81 executes transmission processing of the payout result of credit based on the dividend calculation processing of step S136 and the JP payout result based on the JP bonus game determination processing of step S131 (step S137), similarly to step S115 of FIG. 12. Next, the server CPU 81 transmits a collection signal of the ball 27 to the CPU 101 (step S138), similarly to step S116 of FIG. 13. This subroutine is finished subsequent to the processing of step S138.

Next, the game processing of the roulette will be described referring to FIGS. 14 to 16.

First, as shown in FIG. 14, the CPU 101 receives the control data setting signal from the server CPU 81 (step S221), similarly to step S210 of FIG. 13. The CPU 101 then determines the control data 1 to 6 to be used in the current game, according to the received control data setting signal (step S222).

Here, if the control data setting signal received in step S221 indicates that the control data change condition is met, the CPU 101 determines that change of the control data 1 to 6 is required, and newly specifies control data 1 to 6 different from the previous control data 1 to 6 (candidate for current control data 1 to 6) as the current control data 1 to 6. Here, the CPU 101 determines the next control data 1 to 6 using a random number value sampled in the sampling circuit or the like.

On the other hand, when the control data setting signal received in step S221 indicates that the control data change condition is not met, the CPU 101 determines that no change of the control data 1 to 6 is required and that the previous control data 1 to 6 is also used in the current game without change.

The CPU 101 then transmits the control signal indicating the current control data 1 to 6 determined in step S222 to the server CPU 81 (step S223).

Next, as shown in FIG. 15, the CPU 101 receives the control signal to start operation of the roulette apparatus 3 from the server CPU 81 (step S224), similarly to step S201 of FIG. 11.

Next, the CPU 101 controls the following operations, referring to the one control data which is currently selected among the control data 1 to 6 stored in the control data storage areas 102A to 102F of the ROM 102.

First, the CPU 101 drives the wheel drive motor 106 for a motor drive time set in the control data 1 to 6 determined in step S222 to rotate the roulette wheel 22 (step S225).

Next, if a predetermined time period (e.g., 20 seconds) has elapsed (YES in step S226), similarly to step S203 of FIG. 11, the CPU 101 throws in the ball 27 after the launching delay time elapsed (step S227), similarly to step S204 of FIG. 11, based on the detection signal from the pocket position detecting circuit 107. In this occasion, the CPU 101 throws in the ball at an initial velocity included in the control data 1 to 6 determined in step S222.

Next, the CPU 101 receives the pocket determination signal from the server CPU 81 (step S228), similarly to step S205 of FIG. 12. Subsequently, the CPU 101 drives the ball sensor 105 and determines which of the number pockets 23 has received the ball 27 (step S229), similarly to step S206 of FIG. 12. The CPU 101 then transmits a signal indicating the determination result of the number pocket 23 which has received the ball 27 to the server CPU 81 (step S230), similarly to step S207 of FIG. 12.

Next, the CPU 101 receives the ball collection signal from the server CPU 81 (step S231), similarly to step S208 of FIG. 12. Subsequently, the CPU 101 drives the ball collecting apparatus 108 provided at the lower part of the roulette wheel 22 and collects the ball 27 on the roulette wheel 22 (step S232), similarly to step S209 of FIG. 12. The collected ball 27 is thrown into the roulette wheel 22 again in the next game by the ball throw-in apparatus 104. This subroutine is finished subsequent to the processing of step S232.

As thus described, the roulette gaming machine 1 according to the second embodiment of the present invention includes a roulette wheel 22 having a plurality of pockets 23 numbered respectively, similarly to the roulette gaming machine 1 according to the first embodiment of the present invention. In the roulette wheel 22, every six or seven pockets of the number pockets 23 are grouped into one of the pocket groups 24A to 24F. The respective pocket groups 24A to 24F have corresponding areas A to F arranged on the roulette wheel 22, respectively.

In addition, the roulette gaming machine 1 according to the second embodiment uses one of the control data among the control data 1 to 6 stored in the ROM 102 of the roulette apparatus 3 for rotation of the roulette wheel 22 and throw-in of the ball 27, similarly to the roulette gaming machine 1 according to the first embodiment. Each of control data 1 to 6 raises the probability of receiving the ball 27 into one of the areas A to F on the roulette wheel 22 higher than that in the others of the areas A to F.

Then, if, in each game, the number pocket 23 bet by the players is concentrated on the specific one of the areas A to F with higher probability of receiving the ball 27 based on the control data 1 to 6 used in the previous game, the roulette gaming machine 1 according to the second embodiment changes the control data 1 to 6 to be used in the current game.

Therefore, with the roulette gaming machine 1 according to the second embodiment, entertainment of the game can be enhanced by intentionally biasing the number pocket 23 which is supposed to receive the ball 27 within the specific one of the areas A to F, by controlling rotation of the roulette wheel 22 and throw-in of the ball 27 using the control data 1 to 6.

Moreover, with the roulette gaming machine 1 according to the second embodiment, if betting is concentrated on one of the areas A to F having the probability of receiving the ball 27 intentionally biased, the specific one of the areas A to F with higher probability of receiving the ball 27 is changed in the next game by a control based on another control data 1 to 6. Therefore, the difficulty of predicting the number pocket 23 which is supposed to receive the ball 27 is preserved, whereby entertainment of the game can be enhanced.

Although embodiments of the present invention have been described above, they merely present specific examples and by no means limit the present invention particularly. Specific implementation of the arrangements can be modified in design as appropriate. In addition, the effects set forth in the embodiments of the present invention are merely an enumeration of the most preferred effects resulting from the present invention. The effects of the present invention are by no means limited to those set forth in the embodiments of the present invention.

For example, the roulette gaming machine 1 has been exemplified in the description in the first or the second embodiments. However, the present invention can be applied to other gaming apparatuses such as bingo game, for example.

Also, in the above detailed description, mainly characteristic portions have been set forth so that the present invention can be understood more easily. The present invention is not limited to the embodiments set forth in the above detailed description and can be applied to other embodiments, with a wide range of applications. In addition, terms and wordings used in the present specification are used to precisely describe the present invention and are not intended to limit the interpretation of the present invention. Also, those skilled in the art will easily conceive, from the concept of the invention set forth in the present specification, other arrangements, systems or methods included in the concept of the present invention. Therefore, it should be appreciated that the scope of the claims includes equivalent arrangements without deviating from the scope of technical ideas of the present invention. In addition, the purpose of the abstract is to facilitate the Patent Office and general public institutions, or engineers in the technological field who are not familiar with patent and legal terms or specific terms to quickly evaluate technical contents and the essence of this application by simple investigation. Therefore, the abstract is not intended to limit the scope of the invention, which should be evaluated by descriptions of the scope of the claims. Furthermore, it is desirable to take into consideration the already disclosed literatures sufficiently in order to completely understand the objects and specific effects of the present invention.

The above detailed description includes processes executed by a computer. The aforementioned descriptions and expressions are described with a purpose that those skilled in the art will understand them most efficiently. In the present specification, each step used for deriving one result should be understood as a self-consistent process. Also, transmission, reception and recording of electric or magnetic signals are executed in each step. In the processes in respective steps, although such signals are expressed as bits, values, symbols, characters, terms or numerals, it should be noted that these are merely used for convenience of description. Additionally, although the processes in respective steps may be described using an expression common to human activities, the processes described in the present specification is executed, in principle, by a variety of devices. Furthermore, other arrangements required to execute respective steps are self-evident from the aforementioned description.

What is claimed is:

1. A gaming apparatus comprising:
a roulette wheel which rotates around its center axis;
a plurality of pockets sequentially arranged on the roulette wheel for receiving a ball;
a memory for storing a plurality of control data used for controlling the pocket which receives the ball launched onto the periphery of the roulette wheel in each game; and
a controller operable to control, in each game, the pocket which receives the launched ball using one of the plurality of control data stored in the memory; wherein
the control data raises the probability of receiving the ball in a specific pocket among the plurality of pockets, relatively higher than the probability of receiving the ball in the pockets other than the specific pocket,
the specific pocket with the higher probability of receiving the ball is different for each of the control data, and
the controller is operable to:
(a) accumulate the number of the game media bet on the specific pocket with the higher probability of receiving the ball for each game when the pocket having game media bet thereon is the specific pocket, and
(b) switch the control data when the accumulated number of the game media reaches a predetermined value.

2. The gaming apparatus according to claim 1, wherein
the controller is operable to switch the control data after the game with accumulating the number of the game media is terminated.

3. The gaming apparatus according to claim 1, wherein
the controller is operable to switch the control data before launching the ball onto the peripheral of the roulette wheel in the game with accumulating the number of the game media.

4. A gaming apparatus comprising:
a roulette wheel which rotates around its center axis;
a plurality of areas provided on the roulette wheel;
a plurality of pockets sequentially arranged on the roulette wheel for receiving a ball;
a memory for storing a plurality of control data used for controlling the pocket which receives the ball launched onto the periphery of the roulette wheel in each game; and
a controller operable to control, in each game, the pocket which receives the ball using one of the plurality of control data stored in the memory; wherein
each of the areas has a pocket group, respectively,
each of the pocket groups is composed of the successive pockets which belong to the same area respectively,
the control data raises the probability of receiving the ball in the pocket group included a specific area among the plurality of areas, relatively higher than the probability of receiving the ball in the pocket groups included the areas other than the specific area,
the specific area including the pocket group with the higher probability of receiving the ball is different for each of the control data, and
the controller is operable to:
(a) accumulate the number of the game media bet on the pocket with the higher probability of receiving the ball included the specific area for each game when the area including the pocket having the game media bet thereon is the specific area, and
(b) switch the control data when the accumulated number of the game media reaches a predetermined value.

5. The gaming apparatus according to claim 4, wherein
the controller is operable to switch the control data after the game with accumulating the number of the game media is terminated.

6. The gaming apparatus according to claim 4, wherein
the controller is operable to switch the control data before launching the ball onto the peripheral of the roulette wheel in the game with accumulating the number of the game media.

7. A method of controlling a gaming apparatus, the gaming apparatus comprising:
a roulette wheel which rotates around its center axis;
a plurality of pockets sequentially arranged on the roulette wheel for receiving a ball;
a ball launched onto the peripheral of the roulette wheel in each game; and
a plurality of control data used for controlling the pocket which receives the ball, wherein
the control data raises the probability of receiving the ball in a specific pocket among the plurality of pockets, relatively higher than the probability of receiving the ball in the pockets other than the specific pocket, and
the specific pocket with the higher probability of receiving the ball is different for each of the control data,
the method comprising:
accumulating the number of the game media bet on the specific pocket with the higher probability of receiving the ball for each game when the pocket having game media bet thereon is the specific pocket, and
switching the control data when the accumulated number of the game media reaches a predetermined value.

8. The method of controlling the gaming apparatus according to claim 7, further comprising:
switching the control data after the game with accumulating the number of the game media is terminated.

9. The method of controlling the gaming apparatus according to claim 7, further comprising:
switching the control data before launching the ball onto the peripheral of the roulette wheel in the game with accumulating the number of the game media.

10. A method of controlling a gaming apparatus, the gaming apparatus comprising:
a roulette wheel which rotates around its center axis;
a plurality of areas provided on the roulette wheel;
a plurality of pockets sequentially arranged on the roulette wheel for receiving a ball;
a ball launched onto the peripheral of the roulette wheel for each game; and
a plurality of control data used for controlling the pocket which receives the ball, wherein
each of the areas has a pocket group, respectively,
each of the pocket groups is composed of the successive pockets which belong to the same area respectively,
the control data raises the probability of receiving the ball in the pocket group included a specific area among the plurality of areas, relatively higher than the probability of receiving the ball in the pocket groups included the areas other than the specific area, and
the specific area including the pocked group with the higher probability of receiving the ball is different for each of the control data,
the method comprising:
accumulating the number of game media bet on the pocket with the higher probability of receiving the ball included the specific area for each game when the area including the pocket having the game media bet thereon is the specific area, and
switching the control data when the accumulated number of the game media reaches a predetermined value.

11. The method of controlling the gaming apparatus according to claim 10, further comprising:
switching the control data after the game with accumulating the number of the game media is terminated.

12. The method of controlling the gaming apparatus according to claim 10, further comprising:
switching the control data before launching the ball onto the peripheral of the roulette wheel in the game with accumulating the number of the game media.
